(19) United States
(12) Patent Application Publication
(10) Pub. No.: US 2023/0259547 A1
(43) Pub. Date: Aug. 17, 2023

(54) IMAGE SELECTION APPARATUS, IMAGE SELECTION METHOD, AND NON-TRANSITORY COMPUTER-READABLE MEDIUM

(71) Applicant: NEC Corporation, Minato-ku, Tokyo (JP)

(72) Inventor: Shoji NISHIMURA, Tokyo (JP)

(73) Assignee: NEC Corporation, Minato-ku, Tokyo (JP)

(21) Appl. No.: 18/009,213

(22) PCT Filed: Jun. 11, 2020
(86) PCT No.: PCT/JP2020/023002

§ 371 Date: Dec. 8, 2022

(51) Int. Cl. G06F 16/538; G06F 16/532

(52) U.S. Cl. CPC G06F 16/538; G06F 16/532

(57) ABSTRACT

An image selection apparatus (10) includes a selection unit (110) and a display processing unit (120). The selection unit (110) acquires query information, sets a selection condition of an image by using the query information, and performs processing (hereinafter, described as selection processing) of selecting a plurality of images by using the selection condition. The display processing unit (120) displays the plurality of images selected by the selection unit (110) on a display unit (130), for example, a display. Herein, after the display unit (130) displays the plurality of images, the selection unit (110) acquires a selection input indicating a result of selecting at least one image from the plurality of images. Then, the selection unit (110) changes the selection condition by using the image indicated by the selection input, and performs the selection processing again by using the selection condition after the change.

### TECHNICAL FIELD

The present invention relates to an image selection apparatus, an image selection method, and a program.

### BACKGROUND ART

In recent years, a camera is installed at various places. One of methods for using an image captured by such camera is to select an image that satisfies query information. In image search, an image may be used as query information. For example, Patent Document 1 describes that feature data about each of still images constituting a video to be a query are extracted, and a similar video is searched by using the feature data.

Further, Patent Document 2 discloses the following technique. First, a user registers a plurality of selection key images in a system in advance. Then, the user searches for an image by using a search key image.

Further, Patent Document 3 discloses the following image search apparatus. First, the image search apparatus searches for a similar image, based on an input query image, and acquires a first search result including a plurality of images being ranked. Next, some of the images placed in higher ranks of the first search result are determined as display images. Next, a similar image is searched again, based on the images placed in the higher ranks in the first search result.

Furthermore, Patent Document 4 discloses the following image search apparatus. First, the image search apparatus compares, for a search, an inquiry image selected by a user with N reference images stored in an image database, and extracts K similar images in a matching order. Next, the image search apparatus stores, in a buffer, higher M similar images among the K similar images, and stores remaining (K-M) similar images in a different storage medium. Next, the image search apparatus selects, as a new inquiry image, a highest similar image among the higher M similar images stored in the buffer, performs matching on the M similar images stored in the buffer, and performs rearrangement in the matching order.

### RELATED DOCUMENT

### Patent Document

Patent Document 1: Publication No. 2007-323268
Patent Document 2: Publication No. 2003-150634
Patent Document 3: Publication No. 2010-25059
Patent Document 4: Publication No. 2004-133947

### SUMMARY OF THE INVENTION

### Technical Problem

When an image desired by a user is selected from a plurality of images, an increase in images to be selection targets increases a possibility that an image other than the image desired by the user is included in a selection result. One of challenges to be solved by the present invention is to improve selection accuracy of an image.

### SOLUTION TO PROBLEM

The present invention provides an image selection apparatus including:

a selection unit that acquires query information, sets a selection condition of an image by using the query information, and performs selection processing of selecting a plurality of images by using the selection condition; and

a display processing unit that displays the plurality of images on a display unit, wherein

the selection unit
acquires a selection input indicating a result of selecting at least one image from the plurality of images, and
changes the selection condition by using the image indicated by the selection input, and performs the selection processing again by using the changed selection condition.

The present invention provides an image selection method including,

executing by a computer:

selection processing of acquiring query information, setting a selection condition of an image by using the query information, and performing selection processing of selecting a plurality of images by using the selection condition;

display processing of displaying the plurality of images on a display unit; and

in the selection processing, by the computer,

acquiring a selection input indicating a result of selecting at least one image from the plurality of images; and

changing the selection condition by using the image indicated by the selection input, and performing the selection processing again by using the changed selection condition.

The present invention provides a program causing a computer to include:

a selection function of acquiring query information, setting a selection condition of an image by using the query information, and performing selection processing of selecting a plurality of images by using the selection condition; and

a display function of displaying the plurality of images on a display unit, wherein

the selection function
acquires a selection input indicating a result of selecting at least one image from the plurality of images, and
changes the selection condition by using the image indicated by the selection input, and performs the selection processing again by using the changed selection condition.

### Advantageous Effects of Invention

According to the present invention, selection accuracy of an image improves.

### BRIEF DESCRIPTION OF THE DRAWINGS

The above-described object, the other objects, features, and advantages will become more apparent from suitable example embodiments described below and the following accompanying drawings.

FIG. 1 is a diagram illustrating one example of a functional configuration of an image selection apparatus according to an example embodiment.

FIG. 2 is a diagram illustrating one example of a selection condition stored in a selection unit.

FIG. 3 is a diagram illustrating a hardware configuration example of a main portion of the image selection apparatus.

FIG. 4 is a flowchart illustrating one example of processing performed by the image selection apparatus.

FIG. 5 is a diagram illustrating one example of a screen displayed on a display unit in step S40.

### DESCRIPTION OF EMBODIMENTS

Hereinafter, example embodiments of the present invention will be described with reference to the drawings. Note that, in all of the drawings, a similar component has a similar reference sign, and description thereof will not be repeated as appropriate.

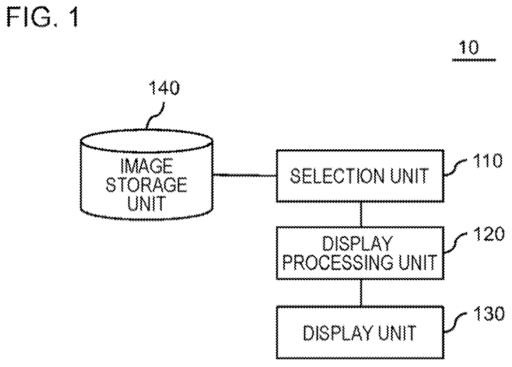

FIG. 1 is a diagram illustrating one example of a functional configuration of an image selection apparatus 10 according to an example embodiment. The image selection apparatus 10 includes a selection unit 110 and a display processing unit 120. The selection unit 110 acquires query information, sets a selection condition of an image (for example, a feature value of an image) by using the query information, and performs processing (hereinafter described as selection processing) of selecting a plurality of images by using the selection condition. The display processing unit 120 displays the plurality of images selected by the selection unit 110 on a display unit 130, for example, a display. Herein, after the display unit 130 displays the plurality of images, the selection unit 110 acquires an input (hereinafter described as a selection input) indicating a result of selecting at least one image from the plurality of images. The selection input is performed by a user of the image selection apparatus 10.

Then, the selection unit 110 changes (for example, corrects) the selection condition by using the image indicated by the selection input, and performs the selection processing again by using the changed selection condition. Note that, the selection unit 110 stores a search condition described above.

An image being a target of the selection processing may be a still image or may be a moving image. In the latter case, a moving image of first piece of query information may be used. In this case, one example of the selection condition is a selection condition indicating a movement of a predetermined moving body (for example, an animal such as human). Herein, one example of “information indicating a movement” is, for example, detection of a plurality of frame images indicating poses different from each other in a predetermined order. Processing performed by the selection unit 110 on each of the frame images is similar to processing performed on a still image.

As described above, the selection unit 110 changes a selection condition by using a selected image. For example, a selection condition may include a plurality of items (for example, a plurality of feature values), and an image may be selected by using scores of the plurality of items. As one example, a degree of similarity is computed by using the scores of the plurality of items, and a condition for selecting the image may be that the degree of similarity is equal to or more than a reference value. In such a case, the selection unit 110 changes an algorithm for selecting an image by using the scores of the plurality of items without changing the item included in the selection condition. As one example, the selection unit 110 changes weighting for a plurality of items when computing a degree of similarity by using scores of the plurality of items. Note that, a coefficient of weighting may be 0.

Herein, a user may select a desired image or may select an undesired image from the images displayed on the display unit 130. In the former case, the selection unit 110 changes the selection condition in such a way that the selected image is more likely to be selected. In the latter case, the selection unit 110 changes the selection condition in such a way that the selected image is less likely to be selected.

Note that, when the selection unit 110 corrects the selection condition, the selection unit 10 may delete some items from the selection condition or may add a new item to the selection condition. Also, in this case, at least one item before correction preferably remains in the selection condition.

When an image includes a person, a user of the image selection apparatus may select an image in which a pose and a movement of a person are similar. In this case, at least some of a plurality of items included in the selection condition are related to a relative position of different portions of a human body with respect to another portion. The portions are, for example, a head and a joint of a person, and the relative position is a line connecting the portions. One example of the portions includes, for example, a head, a neck, a right shoulder, a left shoulder, a right elbow, a left elbow, a right hand, a left hand, a right waist, a left waist, a right knee, a left knee, a right foot, and a left foot.

The query information acquired by the selection unit 110 may include an image, may include text information, or may include both of an image and text information, for example, when the query information is an image, the selection unit 110 extracts a feature value from the image, and sets the feature value as a selection condition. Further, when the query information is text information, the selection unit 110 converts the text information into a selection condition according to a predetermined conversion rule.

Note that, when an image to be the query information indicates a movement of a person, the image may be generated by capturing a person who is performing the movement, or may be generated by computer graphics. In the latter case, a marionette instead of a person may indicate the movement. Then, the image selection apparatus 10 may include a processing unit for the computer graphics.

The selection unit 110 and the display processing unit 120 may repeat the processing described above for a plurality of times. In this case, after the selection processing by the selection unit 110 is performed again, the display processing unit 120 displays a plurality of images selected by the selection processing on the display unit 130 again. The selection unit 110 acquires a selection input again, and then performs a change in the selection condition and the selection processing again.

In the example illustrated in FIG. 1, a plurality of images being a population when an image is selected are stored in an image storage unit 140. The plurality of images are images generated by a surveillance camera, for example. In this case, there may be a plurality of the surveillance cameras. In this case, the plurality of surveillance cameras may be provided away from each other in the same region. Note that, the image storage unit 140 may be a part of the image selection apparatus 10, or may be located outside the image selection apparatus 10.

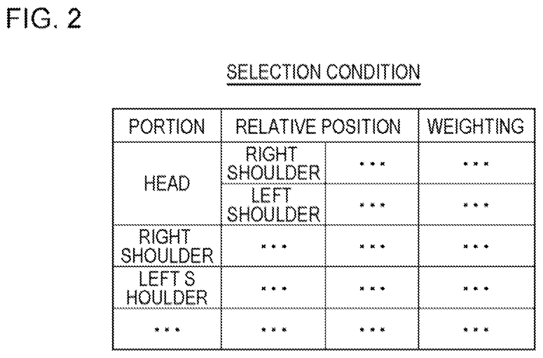

FIG. 2 is a diagram illustrating one example of a selection condition stored in the selection unit 110. In the example in FIG. 2, the selection unit 110 stores a portion of a human body and a relative position as items included in the selection condition. The selection unit 110 also stores weighting by each item.

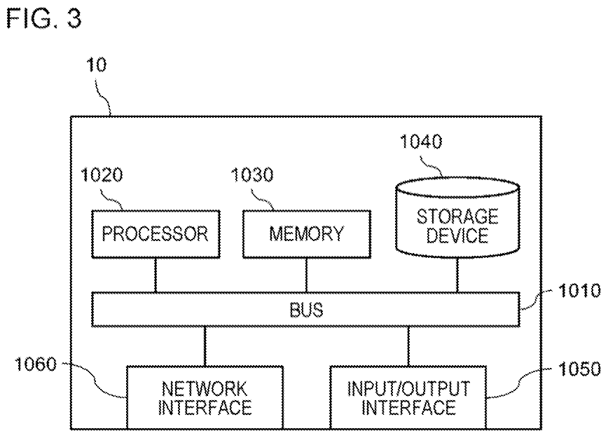

FIG. 3 is a diagram illustrating a hardware configuration example of a main portion of the image selection apparatus 10. The image selection apparatus 10 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method of connecting the processor 1020 and the like to each other is not limited to bus connection.

The processor 1020 is a processor achieved by a central processing unit (CPU), a graphics processing unit (GPU), and the like.

The memory 1030 is a main storage achieved by a random access memory (RAM) and the like.

The storage device 1040 is an auxiliary storage achieved by a hard disk drive (HDD), a solid state drive (SSD), a memory card, a read only memory (ROM), or the like. The storage device 1040 stores a program module that achieves each function (for example, the selection unit 110 and the display processing unit 120) of the image selection apparatus 10. The processor 1020 reads each program module onto the memory 1030 and executes the program module, and each function associated with the program module is achieved. Further, the storage device 1040 may also function as the image storage unit 140.

The input/output interface 1050 is an interface for connecting the image selection apparatus 10 and various types of input/output equipment (for example, the display unit 130).

The network interface 1060 is an interface for connecting the image selection apparatus 10 to a network. The network is, for example, a local area network (LAN) and a wide area network (WAN). A method of connection to the network by the network interface 1060 may be wireless connection or wired connection.

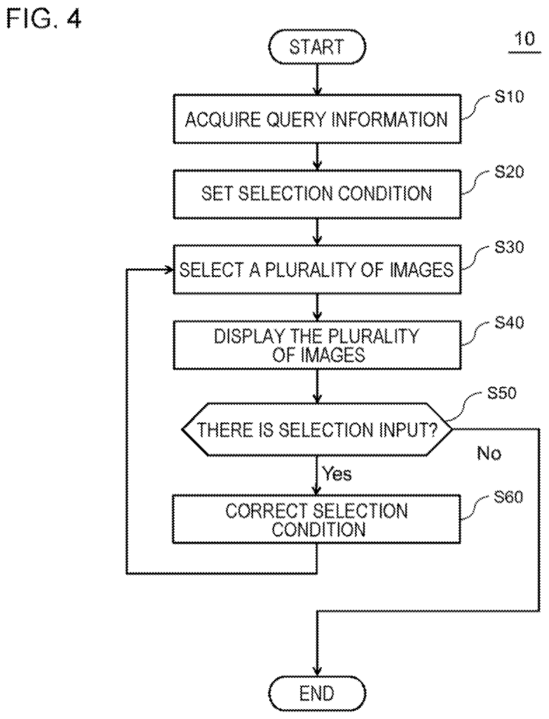

FIG. 4 is a flowchart illustrating one example of processing performed by the image selection apparatus 10. First, a user of the image selection apparatus inputs query information to the selection unit 110 (step S10). Then, the selection unit 110 sets a selection condition by using the input query information (step S20), and selects, by using the selection condition, a plurality of images from images stored in the image storage unit 140 (step S30). The display processing unit 120 displays the plurality of images selected in step S30 on the display unit 130 (step S40).

When the user of the image selection apparatus 10 does not satisfy the selected image, the user selects at least one image from the plurality of images selected by the display unit 130 (step S50: Yes). An input indicating the selection result is performed by using an input device such as a touch panel and a mouse, for example. Herein, the user may select a desired image or may select an undesired image. Then, the selection unit 110 changes the selection condition (step S60), and the processing returns to step S30. Details for the changes to be made herein are as described with reference to FIG. 1.

Then, the processing indicated in step S30 to step S60 is repeated until the user satisfies a selected image (step S50: Yes).

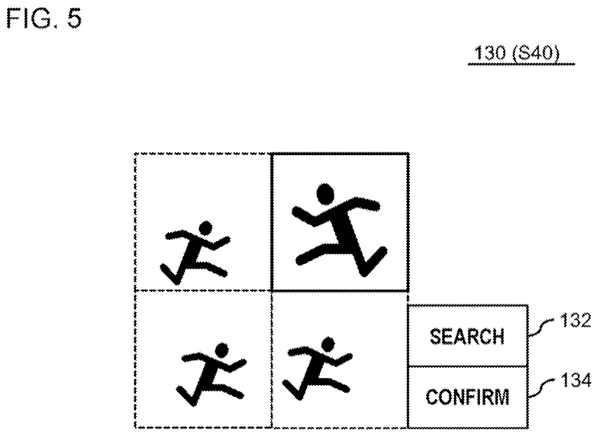

FIG. 5 is a diagram illustrating one example of a screen displayed on the display unit 130 in step S40. In the example illustrated in FIG. 5, the display processing unit 120 displays a plurality of images selected in step S20 in a selectable manner on the display unit 130, and also displays a search button 132 and a confirm button 134. When the user selects at least one image and then further selects the search button 132, the selection unit 110 determines Yes in step S50. Further, when the user selects the confirm button 134, the selection unit 110 determines No in step S50.

As described above, according to the present example embodiment, when the selection unit 110 of the image selection apparatus 10 selects a plurality of images according to query information, and then acquires a selection input of some of the plurality of images from a user, the selection unit 110 changes a selection condition of an image by using an image indicated by the selection input, and selects an image again. Therefore, selection accuracy of an image improves.

While the example embodiments of the present invention have been described with reference to the drawings, the example embodiments are only exemplification of the present invention, and various configurations other than the above-described example embodiments can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, each of the example embodiments described above can be combined within an extent that a content is not inconsistent.

A part or the whole of the above-described example embodiment may also be described in supplementary notes below, which is not limited thereto.

1. An image selection apparatus, including:

a selection unit that acquires query information, sets a selection condition of an image by using the query information, and performs selection processing of selecting a plurality of images by using the selection condition; and

a display processing unit that displays the plurality of images on a display unit, wherein

the selection unit
acquires a selection input indicating a result of selecting at least one image from the plurality of images, and
changes the selection condition by using the image indicated by the selection input, and performs the selection processing again by using the changed selection condition.
   2. The image selection apparatus according to supplementary note 1 described above, wherein,

after the selection processing is performed again, the display processing unit displays the plurality of images selected by the selection processing on the display unit, and

the selection unit then acquires the selection input again, and then changes the selection condition and performs the selection processing again.

3. The image selection apparatus according to supplementary note 1 or 2 described above, wherein

the selection condition includes a plurality of items, and

the selection unit
computes a score of each of the plurality of items, and selects the plurality of images by using the plurality of scores in the selection processing, and
changes weighting for each of the plurality of items by using the image indicated by the selection input, in changing the selection condition.
   4. The image selection apparatus according to supplementary note 3 described above, wherein

the image includes a person, and

at least some of the plurality of items are related to a relative position of different portions of a human body with respect to another portion.

5. The image selection apparatus according to any one of supplementary notes 1 to 4 described above, wherein

the query information includes an image.

6. The image selection apparatus according to any one of supplementary notes 1 to 5 described above, wherein

the query information includes text information.

7. The image selection apparatus according to any one of supplementary notes 1 to 6 described above, wherein

an image to be a target of the selection processing is a moving image.

8. An image selection method, including,

executing by a computer:

selection processing of acquiring query information, setting a selection condition of an image by using the query information, and selecting a plurality of images by using the selection condition;

display processing of displaying the plurality of images on a display unit; and

in the selection processing, by the computer,

acquiring a selection input indicating a result of selecting at least one image from the plurality of images; and

changing the selection condition by using the image indicated by the selection input, and performing the selection processing again by using the changed selection condition.

9. The image selection method according to supplementary note 8 described above, further including:

after the selection processing is performed again, in the display processing, by the computer, displaying the plurality of images selected by the selection processing on the display unit; and,

in the selection processing, by the computer, then acquiring the selection input again, and then changing the selection condition and performing the selection processing again.

10. The image selection method according to supplementary note 8 or 9 described above, wherein

the selection condition includes a plurality of items,

the image selection method further including:

in the selection processing, by the computer,
computing a score of each of the plurality of items, and selecting the plurality of images by using the plurality of scores in the selection processing; and
changing weighting for each of the plurality of items by using the image indicated by the selection input, in changing the selection condition.
   11. The image selection method according to supplementary note 10 described above, wherein

the image includes a person, and

at least some of the plurality of items are related to a relative position of different portions of a human body with respect to another portion.

12. The image selection method according to any one of supplementary notes 8 to 11 described above, wherein

the query information includes an image.

13. The image selection method according to any one of supplementary notes 8 to 12 described above, wherein

the query information includes text information.

14. The image selection method according to any one of supplementary notes 8 to 13 described above, wherein

an image to be a target of the selection processing is a moving image.

15. A program causing a computer to include:

a selection function of acquiring query information, setting a selection condition of an image by using the query information, and performing selection processing of selecting a plurality of images by using the selection condition; and

a display function of displaying the plurality of images on a display unit, wherein

the selection function
acquires a selection input indicating a result of selecting at least one image from the plurality of images, and
changes the selection condition by using the image indicated by the selection input, and performs the selection processing again by using the changed selection condition.
   16. The program according to supplementary note 15 described above, wherein,

after the selection processing is performed again, the display processing function displays the plurality of images selected by the selection processing on the display unit, and

the selection function then acquires the selection input again, and then changes the selection condition and performs the selection processing again.

17. The program according to supplementary note 15 or 16 described above, wherein

the selection condition includes a plurality of items, and

the selection function
computes a score of each of the plurality of items, and selects the plurality of images by using the plurality of scores in the selection processing, and
changes weighting for each of the plurality of items by using the image indicated by the selection input, in changing the selection condition.
   18. The program according to supplementary note 17 described above, wherein

the image includes a person, and

at least some of the plurality of items are related to a relative position of different portions of a human body with respect to another portion.

19. The program according to any one of supplementary notes 15 to 18 described above, wherein

the query information includes an image.

20. The program according to any one of supplementary notes 15 to 19 described above, wherein

the query information includes text information.

21. The program according to any one of supplementary notes 15 to 20 described above, wherein

an image to be a target of the selection processing is a moving image.

### REFERENCE SIGNS LIST

110 Selection unit
120 Display processing unit
130 Display unit
140 Image storage unit

What is claimed is:

1. An image selection apparatus comprising:
at least one memory configured to store instructions; and
at least one processor configured to execute the instructions to perform operations comprising:
acquiring query information, setting a selection condition of an image by using the query information, and performing selection processing of selecting a plurality of images by using the selection condition; and
displaying the plurality of images on a display, wherein
the operations further comprise
acquiring a selection input indicating a result of selecting at least one image from the plurality of images, and
changing the selection condition by using the image indicated by the selection input, and performing the selection processing again by using the changed selection condition.

2. The image selection apparatus according to claim 1, wherein the operations further comprise
displaying, after the selection processing is performed again, the plurality of images selected by the selection processing on the display, and
acquiring the selection input again, and then changing the selection condition and performing the selection processing again.

3. The image selection apparatus according to claim 1, wherein
the selection condition includes a plurality of items, and
the operations further comprise
computing a score of each of the plurality of items, and selecting the plurality of images by using the plurality of scores in the selection processing, and
changing weighting for each of the plurality of items by using the image indicated by the selection input, in changing the selection condition.

4. The image selection apparatus according to claim 3, wherein
the image includes a person, and
at least some of the plurality of items are related to a relative position of different portions of a human body with respect to another portion.

5. The image selection apparatus according to claim 1, wherein
the query information includes an image.

6. The image selection apparatus according to claim 1, wherein
the query information includes text information.

7. The image selection apparatus according to claim 1, wherein
an image to be a target of the selection processing is a moving image.

8. An image selection method comprising,
executing by a computer:
selection processing of acquiring query information, setting a selection condition of an image by using the query information, and selecting a plurality of images by using the selection condition;
display processing of displaying the plurality of images on a display; and
in the selection processing, by the computer,
acquiring a selection input indicating a result of selecting at least one image from the plurality of images; and
changing the selection condition by using the image indicated by the selection input, and performing the selection processing again by using the changed selection condition.

9. A non-transitory computer-readable medium storing a program causing a computer to preform operations comprising:
acquiring query information, setting a selection condition of an image by using the query information, and performing selection processing of selecting a plurality of images by using the selection condition; and
displaying the plurality of images on a display, wherein
the operations further comprise
acquiring a selection input indicating a result of selecting at least one image from the plurality of images, and
changing the selection condition by using the image indicated by the selection input, and performing the selection processing again by using the changed selection condition.
